(19) United States
(12) Patent Application Publication
(10) Pub. No.: US 2022/0076135 A1
(43) Pub. Date: Mar. 10, 2022

(54) META-LEARNING SYSTEM AND METHOD FOR DISENTANGLED DOMAIN REPRESENTATION LEARNING

(71) Applicant: NEC Laboratories America, Inc., Princeton, NJ (US)

(72) Inventors: Zhengzhang Chen, Princeton Junction, NJ (US); Haifeng Chen, West Windsor, NJ (US); Yuening Li, College Station, TX (US)

(21) Appl. No.: 17/391,526

(22) Filed: Aug. 2, 2021

Related U.S. Application Data
(60) Provisional application No. 63/075,421, filed on Sep. 8, 2020.

(51) Int. Cl. G06N 3/08; G06N 5/02; G06N 20/00

(52) U.S. Cl. CPC G06N 3/088; G06N 20/00; G06N 5/022

(57) ABSTRACT

A method for employing meta-learning based feature disentanglement to extract transferrable knowledge in an unsupervised setting is presented. The method includes identifying how to transfer prior knowledge data from a plurality of source domains to one or more target domains, extracting domain dependence features and domain agnostic features from the prior knowledge data, via a disentangle meta-controller, by discovering factors of variation within the prior knowledge data received from a data stream, and obtaining an evaluation for a downstream task, via a child network, to obtain an optimal child model and a feature disentangle strategy.

### RELATED APPLICATION INFORMATION

This application claims priority to Provisional Application No. 63/075,421, filed on Sep. 8, 2020, the contents of which are incorporated herein by reference in their entirety.

### BACKGROUND

### Technical Field

The present invention relates to meta-learning and, more particularly, to a meta-learning system and method for disentangled domain representation learning.

### Description of the Related Art

In the absence of labeled data for a certain task, humans can effectively utilize prior experience and knowledge from a different domain, while artificial learners usually overfit without the necessary prior knowledge. In many applications, a model trained in one source domain performs poorly when applied to a target domain with different statistics due to domain shift. One of the main reasons is that domain-dependent and irrelevant information leads to negative transfer. If a human realizes that the current strategy fails in a new environment, he/she would try to update the strategy to be more context independent to maximize the use of existing resources and prior knowledge. Inspired from the human recognition and learning processes, artificial learning agents learn domain agnostic knowledge that is robust enough to change the domain and perform well in new arrival scenarios.

### SUMMARY

A method for employing meta-learning based feature disentanglement to extract transferrable knowledge in an unsupervised setting is presented. The method includes identifying how to transfer prior knowledge data from a plurality of source domains to one or more target domains, extracting domain dependence features and domain agnostic features from the prior knowledge data, via a disentangle meta-controller, by discovering factors of variation within the prior knowledge data received from a data stream, and obtaining an evaluation for a downstream task, via a child network, to obtain an optimal child model and a feature disentangle strategy.

A non-transitory computer-readable storage medium comprising a computer-readable program for employing meta-learning based feature disentanglement to extract transferrable knowledge in an unsupervised setting is presented. The computer-readable program when executed on a computer causes the computer to perform the steps of identifying how to transfer prior knowledge data from a plurality of source domains to one or more target domains, extracting domain dependence features and domain agnostic features from the prior knowledge data, via a disentangle meta-controller, by discovering factors of variation within the prior knowledge data received from a data stream, and obtaining an evaluation for a downstream task, via a child network, to obtain an optimal child model and a feature disentangle strategy.

A system for employing meta-learning based feature disentanglement to extract transferrable knowledge in an unsupervised setting is presented. The system includes prior knowledge data transferred from a plurality of source domains to one or more target domains, a disentangle meta-controller to extract domain dependence features and domain agnostic features from the prior knowledge data by discovering factors of variation within the prior knowledge data received from a data stream, and a child network to obtain an evaluation for a downstream task to obtain an optimal child model and a feature disentangle strategy.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an exemplary meta-learning based feature disentanglement system including a meta-controller and a child network, in accordance with embodiments of the present invention;

FIG. 2 is a block/flow diagram illustrating updating roles of the outer loop and inner loop, in accordance with embodiments of the present invention;

FIG. 3 is a block/flow diagram of a plurality of sources and a plurality of targets, in accordance with embodiments of the present invention;

FIG. 4 is a block/flow diagram of exemplary equations for index-code mutual information, total correlation, and dimension-wise divergence, in accordance with embodiments of the present invention;

FIG. 5 is a block/flow diagram of an exemplary equation for triplet loss, in accordance with embodiments of the present invention;

FIG. 6 is a block/flow diagram of an exemplary practical application for meta-learning, in accordance with embodiments of the present invention;

FIG. 7 is a block/flow diagram of exemplary Internet-of-Things (IoT) sensors used to collect data/information for meta-learning, in accordance with embodiments of the present invention.

FIG. 8 is an exemplary practical application for the meta-learning based feature disentanglement system, in accordance with embodiments of the present invention;

FIG. 9 is an exemplary processing system for the meta-learning based feature disentanglement system, in accordance with embodiments of the present invention; and

FIG. 10 is a block/flow diagram of an exemplary method for executing the meta-learning based feature disentanglement system, in accordance with embodiments of the present invention.

### DETAILED DESCRIPTION OF PREFERRED EMBODIMENTS

Meta-learning, also known as “learning to learn,” intends to design models that can learn new skills or adapt to new environments rapidly with a few training examples. Conventional systems employ several approaches, including, learning an efficient distance metric (metric-based), using (recurrent) networks with external or internal memory (model-based), and optimizing the model parameters explicitly for fast learning (optimization-based).

A good machine learning model often requires training with a large number of samples. Humans, in contrast, learn new concepts and skills much faster and more efficiently. Kids who have seen cats and dogs only a few times can quickly tell them apart. Is it possible to design a machine learning model with similar properties, that is, learning new concepts and skills fast with a few training examples? That is essentially what meta-learning aims to solve.

The adaptation process, essentially a mini-learning session, happens during test but with a limited exposure to the new task configurations. Eventually, the adapted model can complete new tasks. This is why meta-learning is also known as “learning to learn.”

Identifying what to extract and how to transfer prior knowledge from source domains to target domains is not straightforward, especially when there is no explicit supervision signal. Recently, there has been significant interest in probabilistic generative modeling, which aims to learn useful representations in an unsupervised manner. The general philosophy of the field is to induce alignment of the source and target domains through some transformation. However, such approach restricts the model to understand factors lying in latent space. Therefore, it is difficult to determine the transferable factors in a given domain. In the meantime, recent domain adaptation works usually focus on non-sequential applications, which is inadequate to transfer effective knowledge for sequences like multivariate time series. Temporal correlation plays an important role in analyzing and representing the sequential data, which cannot be appropriately described by directly employing existing methods.

With that in mind, the exemplary embodiments aim to design a meta-learning based feature disentangle strategy to extract transferable knowledge which are invariant from source domains to target domains. The exemplary embodiments focus on how to factor a joint distribution into appropriate conditionals, consistent with the interpretability. The exemplary embodiments exploit the assumption that the given data after successfully being transferred to an appreciated latent space can be decomposed as a domain-dependent distribution and a domain-agnostic distribution. Thus, a disentangled representation, one which explicitly represents the salient and domain-agnostic knowledge, can be helpful for the relevant new domains.

Most related to the present invention, recent research endeavors on domain adaptation have shown potential beneficial results regarding image recognition. However, there are relatively few approaches on learning from sequential data. Sequential data holds unique characteristics. For instance, sequential data often involves multiple independent factors operating at different time scales. Sequential data also includes temporal correlations among different time stamps.

Other initial attempts relate to learning disentangled representations. They require supervised knowledge of the data generative factors. They generally allow the models to infer latent variables from the observed data and optimize the variables from minimizing some measure of domain shift, such as maximum mean discrepancy, correlation alignment distance or adversarial loss. However, the model studies the setting of unsupervised domain adaptation, with labeled data in the source domain, and only unlabeled data in the target domain.

The exemplary embodiments resolve such issues by including two stages, that is, a disentangle meta-controller to detach domain dependence and domain agnostic features by discovering factors of variation within data and a child network to get an evaluation for guiding the optimization.

The exemplary embodiments introduce a model-agnostic meta-controller that trains any given model to be more robust to domain shifts. The meta-controller trains models solely based on source domain, while also ensuring that the direction taken to be suited for few-show tuning to new target domains. To achieve that, the meta-controller, as a generative model, encourages the latent representation detached into interpretable, yet meaningful contents. The exemplary embodiments do so by maximizing the mutual information between a small fixed subset of the latent variables from observations from different domains and by minimizing the index-code mutual information and the total correlation among the rest of the subset of latent variables to learn the model-dependent representations. Thus, the meta-controller can disentangle the latent variables into separated domain-agnostic and domain-dependent parts, which are independent of each other. The domain-agnostic representation takes common knowledge across different domains, and at the same time, the domain-dependent representation extracts domain sensitive features.

The domain-agnostic representation is used as input to a child network to get an evaluation for the downstream task. To find the optimal model, the exemplary embodiments ask the child network to maximize its expected performance in the validation set of the child model. Concurrently, the domain-dependent representation is fed into another domain discriminator. The two tasks are essentially competing with each other as the disentangled features are used to train the child model and the discriminator, respectively. Both the meta-controller and the discriminator play an adversarial game in which the interaction is modeled by a minimax optimization over the prediction of the downstream task.

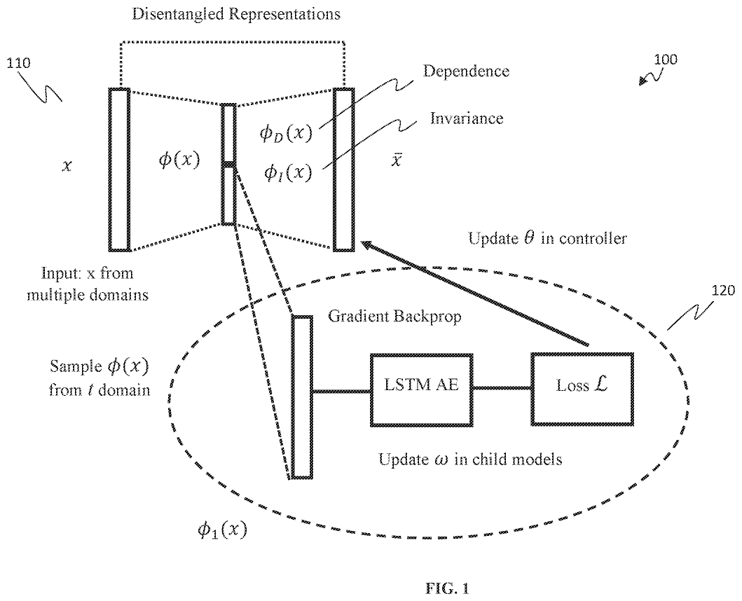

FIG. 1 presents the workflow of the exemplary embodiments of the present invention. To identify what to extract and how to transfer prior knowledge from source domains to target domains, the meta-learning based feature disentanglement system 100 provides a new meta-learning based framework that disentangles the input features into cross domain shareable information. First, a meta-controller 110 tasks inputs from multiple domains, and projects the original space to a latent space, where the representation can be disentangled into interpretable domain dependence and interpretable domain invariance parts. Second, the domain invariance part is used as input to a child network 120. The child model tasks time series pieces into a general long short-term memory (LSTM) autoencoder (AE) network and maximizes its expected performance in the validation set to find the optimal child model as well as the feature disentangle strategy.

Regarding enable disentanglement, the goal of this invention's disentangling representation learning is to discover factors of variation within data, which can be detached into domain agnostic and domain dependent features from multiple source domains. To achieve this, the exemplary embodiments maximize the mutual information between a small, fixed subset of the latent variables from observations from different domains and by minimizing the index-code mutual information and the total correlation among the rest of the subset of the latent variables to learn the model-dependent representations. Thus, the meta-controller 110 can disentangle the latent variables into separated domain-agnostic and domain-dependent parts, which are independent with each other.

Regarding distinguishability, based on the result of the disentangled representations, the exemplary embodiments have the domain-agnostic representation take common knowledge across different domains, and in the meantime, the domain-dependent representation extracts domain sensitive features. To preserve the domain-sensitive characteristics information, the exemplary embodiments also introduce the distinguishability in the domain-dependent parts. The domain-dependent representation is fed into another domain discriminator.

Regarding the inner loop, which relates to updating the child model, the domain-agnostic representation is used as input to the child network 120 to get an evaluation for the downstream task. To find the optimal model, the exemplary embodiments ask the child network to maximize its expected performance in the validation set of the child model. The child model puts time series representations into a general LSTM AE network and maximizes its expected performance in the validation set to find the optimal child model as well as the feature disentangle strategy.

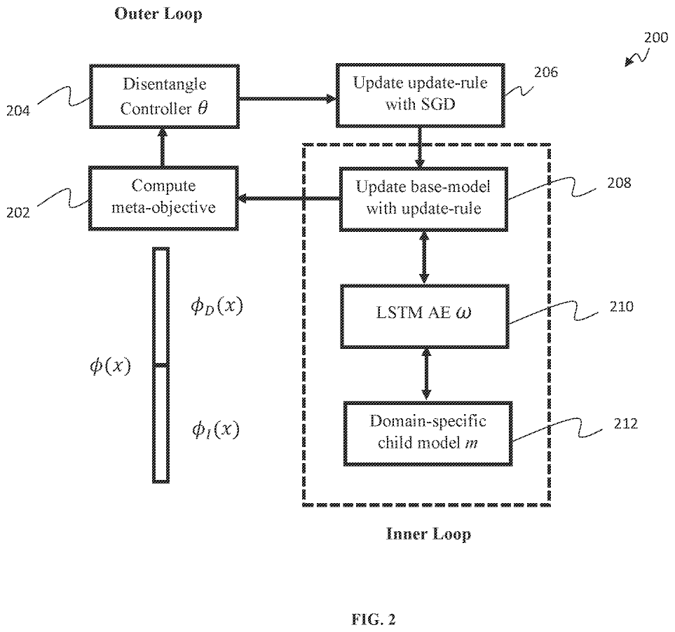

FIG. 2 is a block/flow diagram 200 of updating roles of the outer loop and inner loop, in accordance with embodiments of the present invention.

At block 202, a meta-objective is computed.

At block 204, a disentangle controller θ is employed to disentangle or detach the input features into cross domain shareable information.

At block 206, the update rule is updated with stochastic gradient descent (SGD).

At block 208, the inner loop is entered where the base-model is updated with the update-rule.

At block 210, the child network employs LSTM AE to maximize its expected performance in the validation set.

At block 212, a domain-specific child model m is generated.

With the emergence of sensor technologies and the general instrumentation of the real world, big data analytics are being utilized more frequently to transform large datasets collected by sensors into actionable intelligence. In addition to having a large volume of information, large datasets may also be defined by their heterogeneity and distributed nature. Learners may be utilized to extract and analyze data from a large dataset. Existing distributed data mining techniques may be characterized by limited data access as the result of the application of local learners having limited access to a large and distributed dataset. The applications of such distributed data mining systems to real-world problems across different sites and by different institutions offer the promise of expanding current frontiers in knowledge acquisition and data-driven discovery within the bounds of data privacy constraints that prevent the centralization of all the data for mining purposes. The exemplary embodiments introduce a meta-learning based feature disentanglement system 100 which enable efficient data mining by learners.

In summary, the exemplary embodiments investigated a novel problem of automated deep model search for outlier detection and designed a meta-learning based feature disentangle strategy to extract transferable knowledge across domains. The exemplary embodiments introduced a search strategy built on the theory of curiosity-driven exploration and self-imitation learning. The exemplary embodiments overcome the curse of local optimality, the unfair bias, and inefficient sample exploitation problems. The exemplary embodiments disentangle sequential data from multiple domains into domain-dependent and domain-invariance representations via information theory.

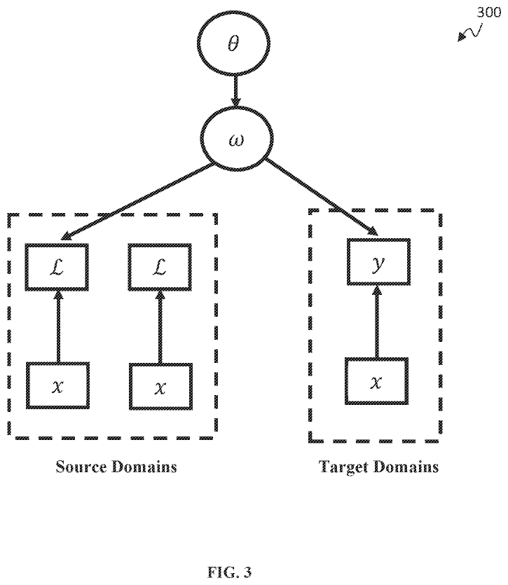

FIG. 3 is a block/flow diagram 300 of a plurality of sources and a plurality of targets, in accordance with embodiments of the present invention.

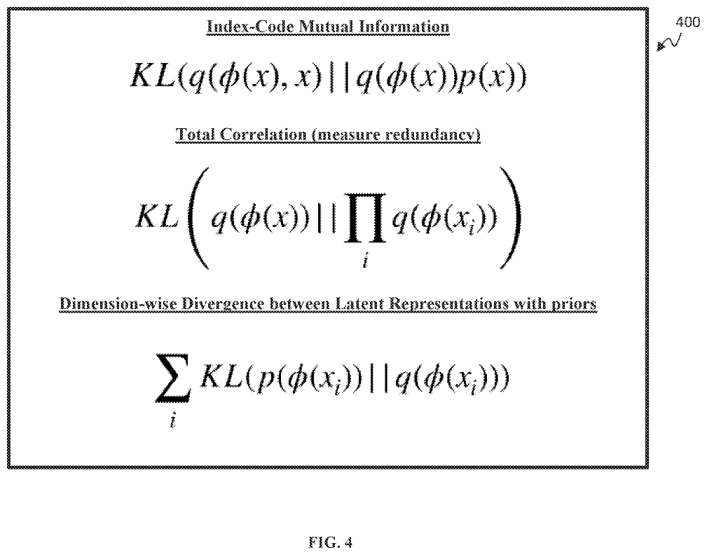

FIG. 4 is a block/flow diagram of exemplary equations 400 for index-code mutual information, total correlation, and dimension-wise divergence, in accordance with embodiments of the present invention.

Updating the first rule (enable disentanglement) requires decomposing the evidence lower bound (ELBO) by employing the following equations.

For the index-code mutual information x:

KL(q(ϕ(x),x)∥q(ϕ(x))p(x))

For the total correlation (measure redundancy):

$$KL ( q ( ϕ ( x ) ) ‖ {\prod }_{i} q ( ϕ ( {x}_{i} ) ) )$$

For the dimension-wise divergence between latent representation with priors:

$${\sum }_{i} KL ( p ( ϕ ( {x}_{i} ) ) ‖ q ( ϕ ( {x}_{i} ) ) )$$

Further disentangling ϕ(x):

I(q(ϕ_{D}(x)),q(ϕ₁(x)))

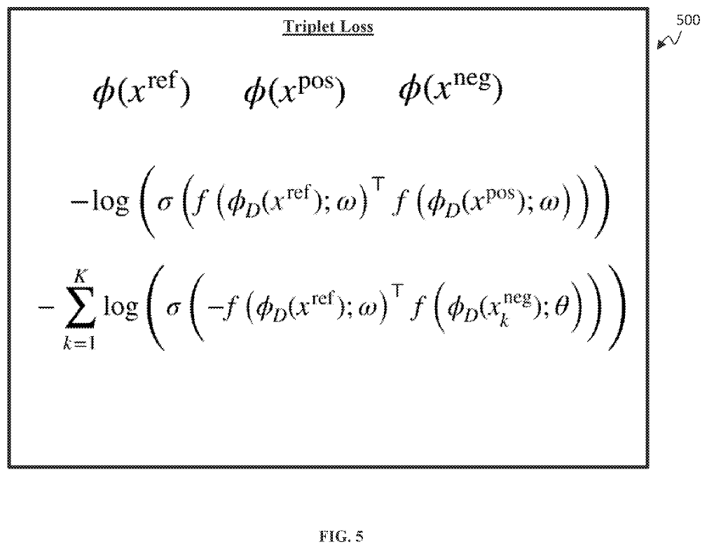

FIG. 5 is a block/flow diagram of an exemplary equation 500 for triplet loss, in accordance with embodiments of the present invention.

Updating the second rule (introducing distinguishability) requires discovering the reasonable task cluster from ϕ_{D} (x) by computing the triplet loss:

$$ϕ ( {x}^{ref} ) ϕ ( {x}^{pos} ) ϕ ( {x}^{neg} ) \\ - log ( σ ( {f ( {ϕ}_{D} ( {x}^{ref} ) ; ω )}^{T} f ( {ϕ}_{D} ( {x}^{pos} ) ; ω ) ) ) \\ - {\sum }_{k = 1}^{K} log ( σ ( - {f ( {ϕ}_{D} ( {x}^{ref} ) ; ω )}^{T} f ( {ϕ}_{D} ( {x}_{k}^{neg} ) ; θ ) ) )$$

Therefore, the goal is to design a meta-learning based feature disentangle strategy to extract transferable knowledge which are invariant from source domains to target domains. Given inputs x from a domain c, the disentangle representation process takes x^{c} as input and outputs a mapping φ(x^{c}). The projection space bridges the source and target domains in an isomorphic latent space. φ(x) can be further disentangled as ϕ_{D} (x) and ϕ₁(x), which denote the domain-dependent features and domain invariance features, respectively. The meta-learning based feature disentanglement system 100 focuses on unsupervised settings.

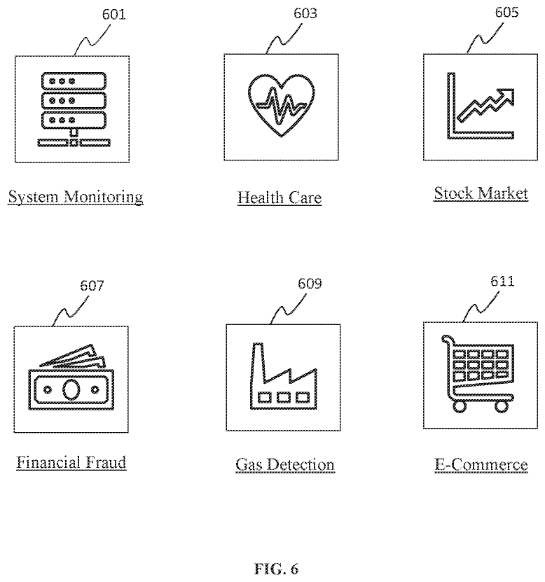

FIG. 6 is a block/flow diagram of an exemplary practical application for meta-learning, in accordance with embodiments of the present invention.

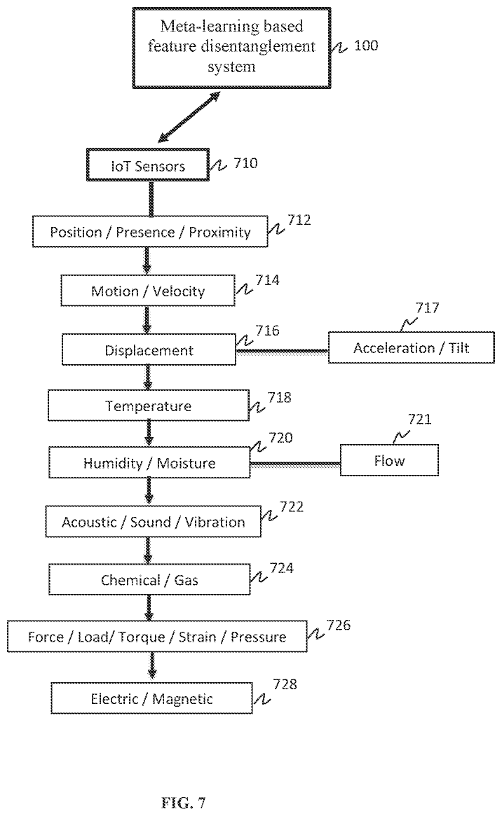

Practical applications for learning and forecasting trends in multivariate time series data can include, but are not limited to, system monitoring 601, healthcare 603, stock market data 605, financial fraud 607, gas detection 609, and e-commerce 611. The time-series data in such practical applications can be collected by sensors 710 (FIG. 7).

FIG. 7 is a block/flow diagram of exemplary Internet-of-Things (IoT) sensors used to collect data/information for meta-learning, in accordance with embodiments of the present invention.

IoT loses its distinction without sensors. IoT sensors act as defining instruments which transform IoT from a standard passive network of devices into an active system capable of real-world integration.

The IoT sensors 710 can communicate with the meta-learning based feature disentanglement system 100 to process information/data, continuously and in in real-time. Exemplary IoT sensors 710 can include, but are not limited to, position/presence/proximity sensors 712, motion/velocity sensors 714, displacement sensors 716, such as acceleration/tilt sensors 717, temperature sensors 718, humidity/moisture sensors 720, as well as flow sensors 721, acoustic/sound/vibration sensors 722, chemical/gas sensors 724, force/load/torque/strain/pressure sensors 726, and/or electric/magnetic sensors 728. One skilled in the art can contemplate using any combination of such sensors to collect data/information for input into the meta-learning based feature disentanglement system 100 for further processing. One skilled in the art can contemplate using other types of IoT sensors, such as, but not limited to, magnetometers, gyroscopes, image sensors, light sensors, radio frequency identification (RFID) sensors, and/or micro flow sensors. IoT sensors can also include energy modules, power management modules, RF modules, and sensing modules. RF modules manage communications through their signal processing, WiFi, ZigBee®, Bluetooth®, radio transceiver, duplexer, etc.

Moreover data collection software can be used to manage sensing, measurements, light data filtering, light data security, and aggregation of data. Data collection software uses certain protocols to aid IoT sensors in connecting with real-time, machine-to-machine networks. Then the data collection software collects data from multiple devices and distributes it in accordance with settings. Data collection software also works in reverse by distributing data over devices. The system can eventually transmit all collected data to, e.g., a central server.

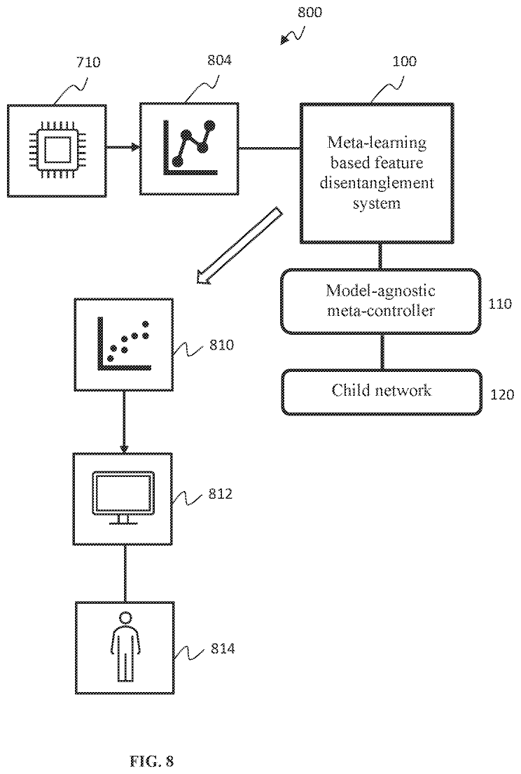

FIG. 8 is a block/flow diagram 800 of a practical application of the meta-learning based feature disentanglement system, in accordance with embodiments of the present invention.

In one practical example, sensors 710 collect data 804. The exemplary methods employ the meta-learning based feature disentanglement system 100 via a meta-controller 110 and a child network 120. In one instance, meta-learning based feature disentanglement system 100 can disentangle IoT data to determine an optimal child model and a feature disentangle strategy. The results 810 (e.g., sensor data/optimal child model/disentangle strategy) can be provided or displayed on a user interface 812 handled by a user 814.

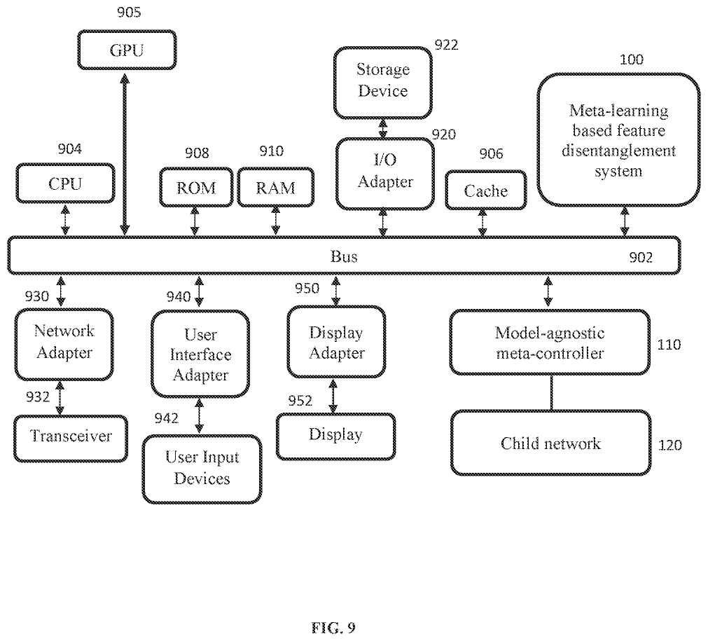

FIG. 9 is an exemplary processing system for the meta-learning based feature disentanglement system, in accordance with embodiments of the present invention.

The processing system includes at least one processor (CPU) 904 operatively coupled to other components via a system bus 902. A graphical processing unit (GPU) 905, a cache 906, a Read Only Memory (ROM) 908, a Random Access Memory (RAM) 910, an input/output (I/O) adapter 920, a network adapter 930, a user interface adapter 940, and a display adapter 950, are operatively coupled to the system bus 902. Additionally, meta-learning based feature disentanglement system 100 can be employed to execute a meta-controller 110 and a child network 120.

A storage device 922 is operatively coupled to system bus 902 by the I/O adapter 920. The storage device 922 can be any of a disk storage device (e.g., a magnetic or optical disk storage device), a solid-state magnetic device, and so forth.

A transceiver 932 is operatively coupled to system bus 902 by network adapter 930.

User input devices 942 are operatively coupled to system bus 902 by user interface adapter 940. The user input devices 942 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 942 can be the same type of user input device or different types of user input devices. The user input devices 942 are used to input and output information to and from the processing system.

A display device 952 is operatively coupled to system bus 902 by display adapter 950.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system are readily contemplated by one of ordinary skill in the art given the teachings of the present invention provided herein.

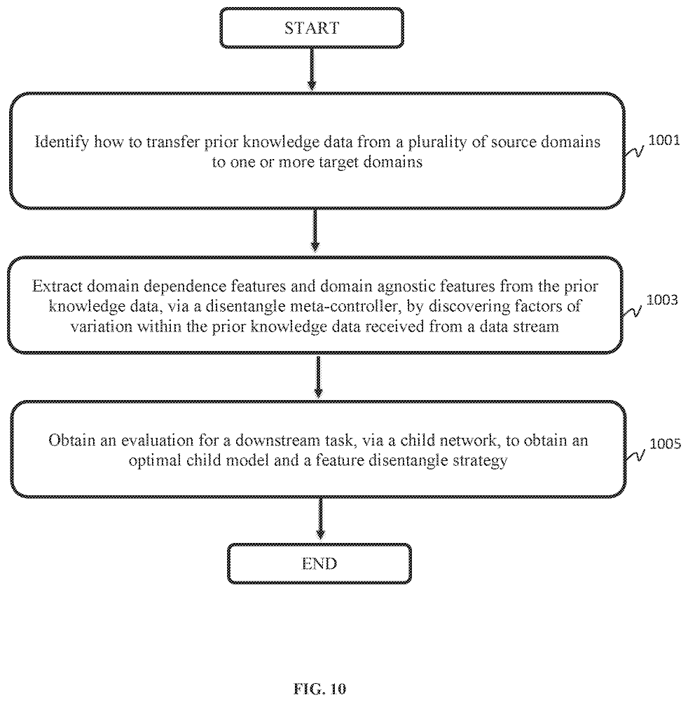

FIG. 10 is a block/flow diagram of an exemplary method for executing the meta-learning based feature disentanglement system, in accordance with embodiments of the present invention.

At block 1001, identify how to transfer prior knowledge data from a plurality of source domains to one or more target domains.

At block 1003, extract domain dependence features and domain agnostic features from the prior knowledge data, via a disentangle meta-controller, by discovering factors of variation within the prior knowledge data received from a data stream.

At block 1005, obtain an evaluation for a downstream task, via a child network, to obtain an optimal child model and a feature disentangle strategy.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for employing meta-learning based feature disentanglement to extract transferrable knowledge in an unsupervised setting, the method comprising:
identifying how to transfer prior knowledge data from a plurality of source domains to one or more target domains;
extracting domain dependence features and domain agnostic features from the prior knowledge data, via a disentangle meta-controller, by discovering factors of variation within the prior knowledge data received from a data stream; and
obtaining an evaluation for a downstream task, via a child network, to obtain an optimal child model and a feature disentangle strategy.

2. The method of claim 1, wherein the disentangle meta-controller trains models solely based on one or more of the plurality of source domains.

3. The method of claim 1, wherein the disentangle meta-controller projects an original space to a latent space.

4. The method of claim 3, wherein, in the latent space, representations are disentangled into an interpretable domain dependence part and an interpretable domain invariance part, the interpretable domain dependence part and the interpretable domain invariance part being independent of each other.

5. The method of claim 4, wherein the interpretable domain invariance part is provided as input to the child network.

6. The method of claim 1, wherein the child network employs a long short-term memory (LSTM) autoencoder network to obtain the optimal child model.

7. The method of claim 1, wherein the discovering of the factors of variation within the data involves maximizing mutual information between a first subset of latent variables from observations from different source domains of the plurality of source domains.

8. The method of claim 7, wherein the discovering of the factors of variation within the data involves minimizing index-code mutual information and a total correlation between a second subset of latent variables to learn model-dependent representations.

9. A non-transitory computer-readable storage medium comprising a computer-readable program for employing meta-learning based feature disentanglement to extract transferrable knowledge in an unsupervised setting, wherein the computer-readable program when executed on a computer causes the computer to perform the steps of:
identifying how to transfer prior knowledge data from a plurality of source domains to one or more target domains;
extracting domain dependence features and domain agnostic features from the prior knowledge data, via a disentangle meta-controller, by discovering factors of variation within the prior knowledge data received from a data stream; and
obtaining an evaluation for a downstream task, via a child network, to obtain an optimal child model and a feature disentangle strategy.

10. The non-transitory computer-readable storage medium of claim 9, wherein the disentangle meta-controller trains models solely based on one or more of the plurality of source domains.

11. The non-transitory computer-readable storage medium of claim 9, wherein the disentangle meta-controller projects an original space to a latent space.

12. The non-transitory computer-readable storage medium of claim 11, wherein, in the latent space, representations are disentangled into an interpretable domain dependence part and an interpretable domain invariance part, the interpretable domain dependence part and the interpretable domain invariance part being independent of each other.

13. The non-transitory computer-readable storage medium of claim 12, wherein the interpretable domain invariance part is provided as input to the child network.

14. The non-transitory computer-readable storage medium of claim 9, wherein the child network employs a long short-term memory (LSTM) autoencoder network to obtain the optimal child model.

15. The non-transitory computer-readable storage medium of claim 9, wherein the discovering of the factors of variation within the data involves maximizing mutual information between a first subset of latent variables from observations from different source domains of the plurality of source domains.

16. The non-transitory computer-readable storage medium of claim 7, wherein the discovering of the factors of variation within the data involves minimizing index-code mutual information and a total correlation between a second subset of latent variables to learn model-dependent representations.

17. A system for employing meta-learning based feature disentanglement to extract transferrable knowledge in an unsupervised setting, the system comprising:
a disentangle meta-controller to extract domain dependence features and domain agnostic features from prior knowledge data transferred from a plurality of source domains to one or more target domains by discovering factors of variation within the prior knowledge data received from a data stream; and
a child network to obtain an evaluation for a downstream task to obtain an optimal child model and a feature disentangle strategy.

18. The system of claim 17, wherein the disentangle meta-controller trains models solely based on one or more of the plurality of source domains.

19. The system of claim 17, wherein the disentangle meta-controller projects an original space to a latent space.

20. The system of claim 19, wherein, in the latent space, representations are disentangled into an interpretable domain dependence part and an interpretable domain invariance part, the interpretable domain dependence part and the interpretable domain invariance part being independent of each other.
